(19) United States
(12) Patent Application Publication
(10) Pub. No.: US 2011/0284087 A1
(43) Pub. Date: Nov. 24, 2011

(54) PASSIVE OIL COLLECTION AND RECOVERY SYSTEM

(75) Inventors: Vitaly J. VODYANOY, Auburn, AL (US); Timothy E. MOORE, Auburn, AL (US); Kenny V. BROCK, Auburn, AL (US); Oleg M. PUSTOVYY, Auburn, AL (US)

(73) Assignee: AUBURN UNIVERSITY, Auburn, AL (US)

(21) Appl. No.: 13/110,387

(22) Filed: May 18, 2011

Related U.S. Application Data
(60) Provisional application No. 61/345,638, filed on May 18, 2010.
(60) Provisional application No. 61/349,591, filed on May 28, 2010.
(60) Provisional application No. 61/349,596, filed on May 28, 2010.
(60) Provisional application No. 61/353,006, filed on Jun. 9, 2010.
(60) Provisional application No. 61/356,871, filed on Jun. 21, 2010.
(60) Provisional application No. 61/358,096, filed on Jun. 24, 2010.
(60) Provisional application No. 61/374,834, filed on Aug. 18, 2010.

(51) Int. Cl. F15D 1/00

(52) U.S. Cl. 137/1; 137/343

(57) ABSTRACT

A system and method for passive collection of oil from water based on a density differential. A sealed column of water is elevated above the oil/water surface within a low pressure contained volume, and oil moves upward into the contained volume displacing the water due to the lower density of the oil. Filled containers of oil are exchanged for containers of water, or oil is transferred from the filled containers.

### CROSS-REFERENCE TO RELATED APPLICATIONS

This application claims the benefit of U.S. Provisional Patent Application Ser. No. 61/345,638, filed May 18, 2010, U.S. Provisional Patent Application Ser. No. 61/349,591, filed May 28, 2010, U.S. Provisional Patent Application Ser. No. 61/349,596, filed May 28, 2010, U.S. Provisional Patent Application Ser. No. 61/353,006, filed Jun. 9, 2010, U.S. Provisional Patent Application Ser. No. 61/356,871, filed Jun. 21, 2010, U.S. Provisional Patent Application Ser. No. 61/358,096, filed Jun. 24, 2010, and U.S. Provisional Patent Application Ser. No. 61/374,834, filed Aug. 18, 2010, the entireties of which are hereby incorporated herein by reference for all purposes.

### TECHNICAL FIELD

The present invention relates generally to the field of collection systems and methods, and more particularly to a system and method for passive collection of oil or other material based on a density differential between the material to be collected and another material.

### BACKGROUND

Oil spills such as the 2010 Deepwater Horizon spill in the Gulf of Mexico and the Exxon Valdez spill in Prince William Sound off the coast of Alaska underscore the need for improved oil collection and recovery. Beyond such high-profile disasters, numerous smaller spills and releases have the potential to contaminate seas and freshwater bodies, as well as cause ground contamination.

Current collection technologies include the use of chemical dispersants, collection booms, biodegrading bacteria, and skimmer vessels. Currently known techniques, however, often have limited effectiveness and applicability. For example, skimmer collection commonly collects a mixture of oil and water that may be up to 90% or more of water, increasing the volume of material to be treated or disposed of, and typically rendering recovery of a commercially usable product infeasible. And chemical dispersants may cause their own environmental concerns, apart from the materials they are intended to treat.

Accordingly, it can be seen that needs exist for improved systems and methods for collection of oil and other materials. It is to the provision of improved systems and methods meeting these and other needs that the present invention is primarily directed.

### SUMMARY

The present invention provides improved systems and methods for collection of oil and other materials. Example forms of the invention provide passive collection of materials based on a density differential between a first material and a second material. Example embodiments of the invention advantageously provide substantially complete separation of collected materials, such that a commercially usable product may be recovered. Example embodiments of the invention further provide for collection of materials without requirement of moving mechanical parts, are scalable depending upon the intended application, are economical, and can be utilized in freshwater or saltwater environments.

In one aspect, the present invention relates to a system for collecting a lower density material from a higher density material. The system includes a container having a closed upper portion and a lower portion having an opening formed therein. The system also has a support structure for supporting the container with its upper portion elevated above a surface comprising the lower density material and maintaining the opening in the lower portion of the container in fluid communication with the lower density material.

In another aspect, the invention relates to a system for collection of oil from an oil layer dispersed on a surface of a body of water. The system includes a container having a lower opening and an internal contained volume. The system also includes at least one floatation device for floatation on the body of water and a means for carrying the container on the at least one floatation device with the lower opening in communication with the oil layer, and with the internal contained volume elevated above the lower opening.

In still another aspect, the invention relates to a method for collection of a lower density material from a higher density material. The method includes placement of a container with a transfer opening in fluid communication with the lower density material. The method also includes charging a contained volume of the container with a quantity of the higher density material. The method further includes positioning the container with its contained volume elevated above the transfer opening and maintaining an airtight seal around the contained volume to retain an elevated column of fluid. And, the method includes allowing transfer of the lower density material through the transfer opening into the contained volume to displace the higher density material therefrom.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1A shows a sealed column of fluid demonstrating generation of a Torricellian vacuum or low-pressure area.

FIG. 1B shows application of the Torricelli principle with a collection vessel according to an example embodiment of the invention.

FIGS. 2A-2B schematically demonstrate a sequence of operation of a system and method for oil collection according to an example embodiment of the present invention.

FIG. 3 shows another example embodiment of a collection system according to the present invention.

FIGS. 4A-4D depict another example embodiment of a collection system according to the present invention, showing a sequence of operation using a repositionable barrel collection vessel.

FIG. 5 shows another example embodiment of a collection system according to the present invention, utilizing a submerging pontoon ballast system.

FIGS. 6A-6C show a leveling sensor system according to an example embodiment of the present invention.

FIGS. 7A and 7B show systems and methods for collection and delivery of a collected material from collection systems according to further example embodiments of the present invention.

FIG. 8 shows another example embodiment of a collection system according to the present invention, utilizing a remote collection head with a flexible conduit for transporting collected material to a collection container.

FIG. 9 shows another example embodiment of a collection system according to the present invention, utilizing multiple collection heads and tanker-based containment and transport of collected material.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

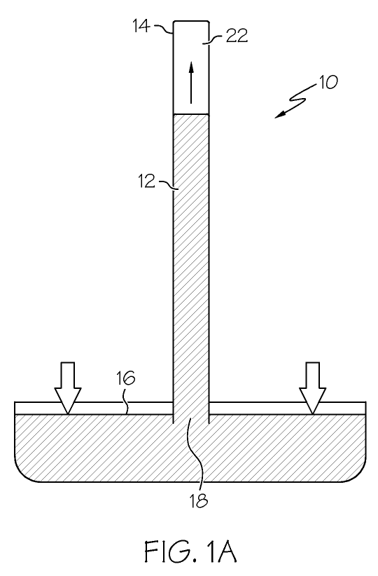

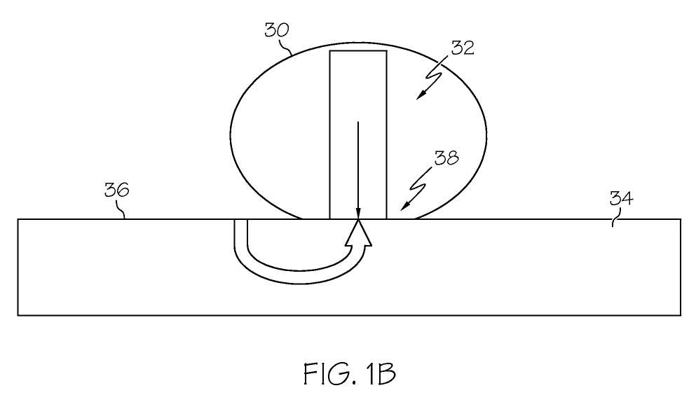

With reference now to the drawing figures, wherein like reference numbers represent corresponding parts throughout the several views, FIG. 1A demonstrates the basic principles of a Torricelli barometer 10. A column of liquid 12, such as for example mercury, fills a tube 14 extending a distance vertically above a liquid surface 16. The top of the tube 14 is sealed, and the bottom of the tube has an opening 18 in sealing contact with or submerged below the liquid surface 16. The column of liquid 12 falls within the tube 14, creating a void 22 under vacuum at the top of the tube. Variation of the atmospheric pressure acting on the liquid surface 16 causes the column of liquid to rise or fall within the tube 14, allowing barometric pressure to be read as a function of the height of the column 12.

As shown in FIG. 1B, the principle of the Torricelli column may be applied to a vessel 30 of any shape, open at one end and filled with water or other liquid 32, which when inverted into a body of water 34 or other liquid with the opening submerged beneath the surface 36 of the body will result in the creation of a low pressure area within the vessel 30. If the surface 36 of the surrounding water is covered with oil (or any other liquid that has a density less than that of water) the oil will be drawn through the vessel's opening toward the lower pressure area at the top due to the density differential. As the oil or other lower density material moves into the vessel the oil will displace an equal volume of water or other higher density material from within the vessel, which is discharged through the opening 38 at the bottom of the vessel 30. The pressure P of the water column in the inverted vessel is calculated by Pascal's law and does not depend on shape of the vessel: P=ρgH, where ρ is the fluid density (in kilograms per cubic meter in the SI system, approximately 1000 kg/m³ for fresh water, about 1027 kg/m³ for ocean saltwater), g is acceleration due to gravity (using the sea level acceleration due to Earth's gravity in meters/second squared, ˜9.8 m/s²), H is a column is fluid column height in meters, and P is a pressure in Pa (N/m²). 1 atm=105 N/m². According to Pascal's equation, for a 10 m high column this results in a pressure of P=1000 kg/m³×9.8 m/s²×10 m=105 N/m=1 atm.

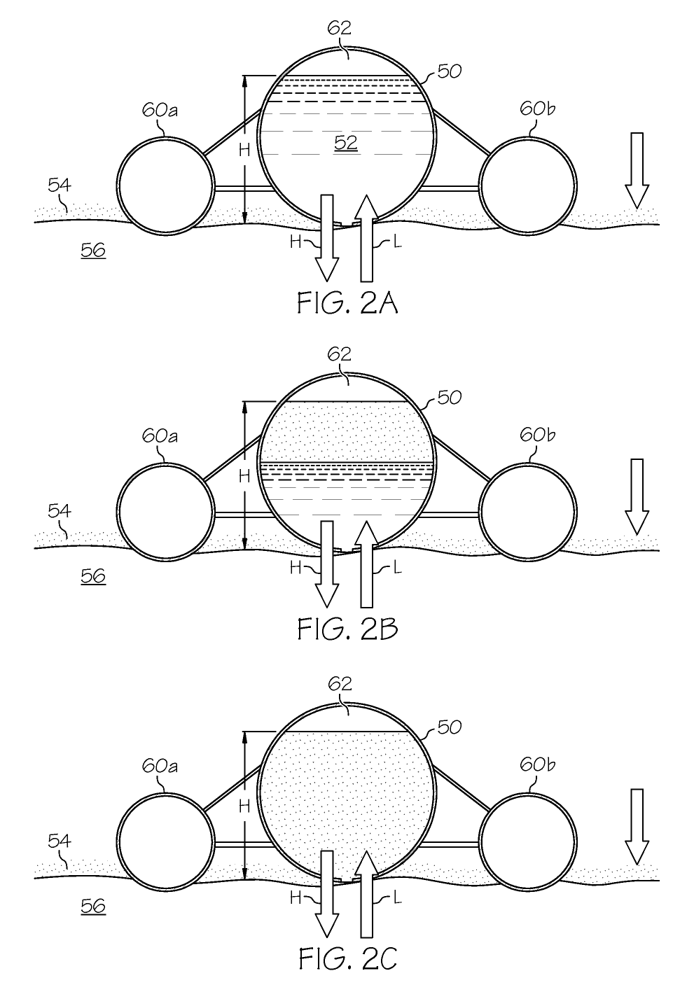

FIGS. 2A, 2B and 2C schematically depict the application of these principles to an example embodiment of a system and method for collection of material according to the present invention. A container vessel 50 having an opening at its bottom is initially filled with water or other higher density liquid 52, as shown in FIG. 2A, and positioned with its opening submerged within or adjacent a layer of lower (relative to the density of the higher density liquid) density liquid 54 such as a layer of oil in or on a body of fresh or salt water 56. The container vessel 50 is held with substantially all or at least a portion of its closed contained volume above the surface level of the lower density liquid, for example by one or more pontoons or other balance tanks 60 (two are shown, 60a and 60b) affixed to the container. Optionally, the buoyancy level of the system is controlled, for example by pumping air and/or water into the balance tanks, to maintain the opening of the container 50 within or proximal to the layer of lower density liquid. Alternatively, the container vessel can be kept on the surface being harnessed with a cable (or shaft) attached to the stationary or floating body, like shore pole, oil rig, and the like.

In this manner, a column of the higher density liquid 52 is defined within the container 50, and held a height H above the surface of the lower density liquid 54, with a Torricellian vacuum in a region at the top 62 of the container 50. As noted above, if the height H of the column of liquid within the container 50 is less than 10 meters, the pressure of the column is balanced by the atmospheric pressure. Accordingly, in preferred forms, the container of systems according to embodiments of the invention has a vertical contained volume dimension or height of about 10 meters or less.

The bottom opening of the container preferably has a size and shape configured to maintain sealing contact with or beneath the surface of the body of water upon which the system is deployed, for example an opening diameter of about 20% or less the height of the container. For applications in rougher seas, an opening dimension of no more than about 10-20% the container height, or no more than about 15-20% the container height is preferred. For example, an opening diameter of about 1.5 m-2 m may be provided for a container of 10 m in height. Opening dimensions of greater than 20% the container height may find application in very smooth waters such as for example an enclosed containment basin, or in systems utilizing active buoyancy control, however, and are within the scope of the invention. The closed and airtight upper portion of the container and the sealing contact with the water/oil surface around the lower opening of the container assist in maintaining of the balancing the internal water weight by the atmospheric pressure. If the seal of the container is broken at the top, the atmospheric pressure applied to the water column top is equilibrated with the atmospheric pressure applied to the water column bottom and the container will lose its content. The opening may define a circular, oblong, elliptical, polygonal, or other regular or irregular peripheral shape. There can be multiple openings as long as the total opening area meets the above requirements. A screen or filter is optionally provided to prevent debris from entering the bottom opening but permitting passage of the oil or other low density liquid to be collected.

As a result of its lower density, the lower density liquid 54 surrounding the opening of the container 50 is drawn upward into the container replacing the higher density liquid 52 from the container, as shown in FIG. 2B. Direction arrow L indicates the inflow of lower density liquid 54 into the container 50, and direction arrow H indicates the outflow of higher density liquid 52 from the container. If a sufficient quantity of lower density liquid 54 is present in the area surrounding the opening of the container 50, over a period of time the container will fill with the lower density liquid, replacing substantially all of the higher density liquid therefrom. FIG. 2B shows a point about midway in the process with the container partially filled with the lower density material, and FIG. 2C shows the final state with the container substantially filled with the lower density material. At this point, the container may be closed for transport, and/or the lower density material collected for further processing, use or disposal.

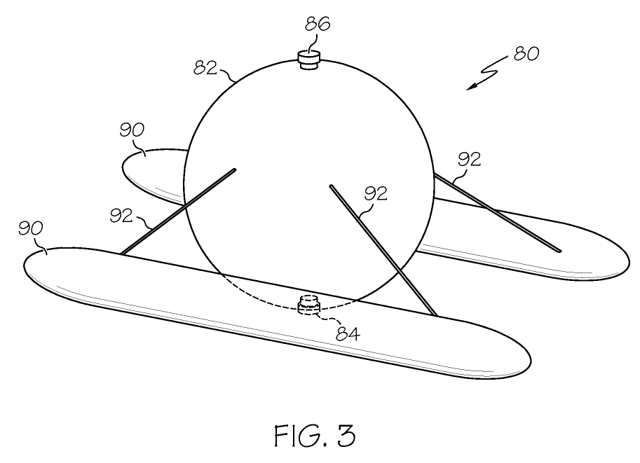

FIG. 3 shows another embodiment of a collection system 80 according to an example form of the invention. A generally spherical container vessel 82 optimizes the ratio of contained volume to surface area, and a rounded lower surface provides more laminar flow and stability as the system moves through water or when positioned within a moving flow of water. For example, a spherical container of 2.5 meters in diameter has a volume capacity of about 8170 liters, or approximately 43 barrels of oil that can be collected therein. As noted above, the system of the present invention is scalable up to about 10 meters in height, providing potential for substantially larger collection volumes up to a 10 m diameter collection sphere. The container 82 includes a valved lower opening 84 for exchange of oil or other lower density material to be collected with water or other higher density material initially charged into the container when the valve is opened, and for sealing the contents of the container when the valve is closed. The container 82 also includes a valved upper opening 86 to allow draining of collected material and/or refilling of the container with an initial charge of higher density material when opened, and to seal the upper portion of the container when closed. The container 82 is mounted between a pair of pontoons 90 for flotation and secured in place by support struts 92 attaching the container to the pontoons. The buoyancy of the pontoons 90 maintains the container 82 with the lower opening in contact with or slightly submerged below the surface on which the system is carried. The container 82 is initially charged with a quantity of higher density material to form a column of liquid within the container above the surface. Opening the oil/water exchange valve in the lower opening 84 allows lower density material to replace the higher density material in the container 82. When the container is substantially full or filled to a desired level with the lower density material, the exchange valve may be closed to seal the lower opening, and the drain valve in the upper opening 86 opened to allow collection of the lower density material. The full container can then be exchanged with another container for further collection, or the lower density material can be collected from the container and the container refilled with higher density material and the collection sequence repeated.

The system optionally includes depth positioning control means for maintaining the lower opening of the container in contact with the surface or at a specified depth below the surface, for example by varying the buoyancy of the pontoons by water/air exchange or other ballast means, and/or by controlling the elevation of the container opening relative to the pontoons. One-way flow valves or flow gates are optionally provided to allow entry of material through the lower opening of the container, but prevent unintentional discharge therefrom. Also, the pontoons and/or other components of the floatation platform of the system are optionally configured to increase collection efficiency by directing or canalizing oil toward the container's lower opening for collection. The system optionally includes a tow assembly for attachment to a boat or other transport vehicle, and/or a motor or other onboard propulsion means. The container size and density of deployment of one or more collection systems in an area may vary depending upon the application.

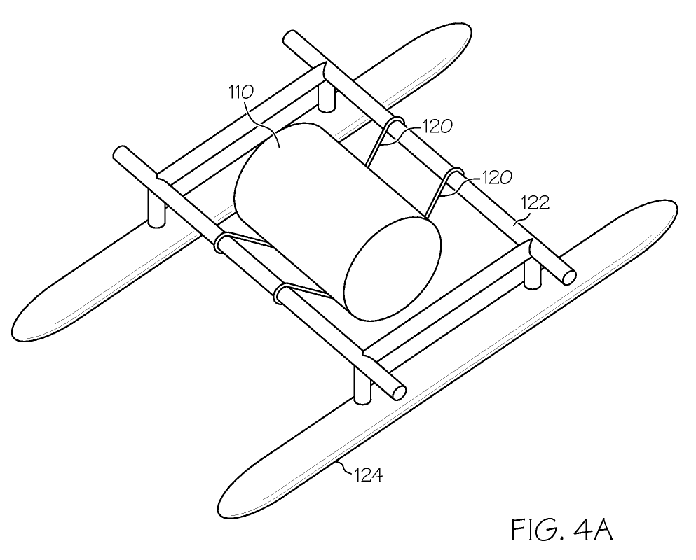

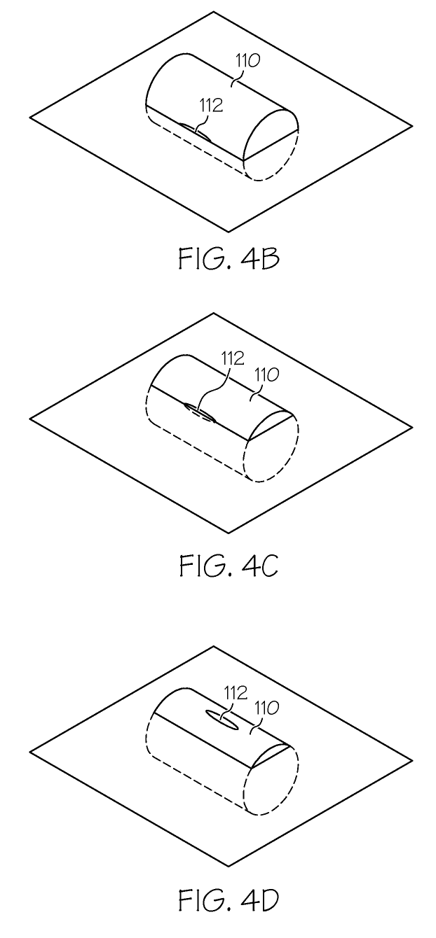

FIGS. 4A-4D show a sequence of operation according to another embodiment of the collection system and method of the present invention. A cylindrical barrel or drum container 110 has a collection opening 112, and is supported by a sling 120 secured to a support frame 122 mounted to pontoon floats 124. Optionally, the container 110 may be a standard forty-two gallon oil drum for compatibility and use with conventional handling and processing equipment, or alternatively may be a specialized drum having a diameter of up to about 10 meters. The sling 120 optionally comprises one or more cables, straps, ropes, webbing or other flexible members, and is optionally coupled to a winch, lift or other mechanism for raising and lowering the container 110, and rotating the container to fill and position the container for use. Alternatively, a support platform or carrier supports the container 110 and can be raised and lowered to fill and position the container. As shown in FIGS. 4B-4D, the barrel 110 is filled with water by rotating the opening 112 to allow water to enter the barrel. The barrel 110 is lowered and allowed to submerge as it fills. When filled, the barrel 110 is rotated to position the opening 112 at the bottom of the barrel, facing downward. The barrel 110 is then lifted until the opening is at or just below the water surface, in fluid communication with the layer of oil to be collected, as shown in FIG. 4a. Oil then enters the barrel 110 to displace the water due to the density differential under the influence of the lower pressure region formed in the interior of the barrel. When oil has substantially completely displaced the water in the barrel 110, the opening 112 is optionally closed or sealed, the barrel is rotated to bring the opening to the top, facing upward. The barrel is then replaced with a fresh barrel for further collection, or it's contents transferred to a collection vessel and the process repeated.

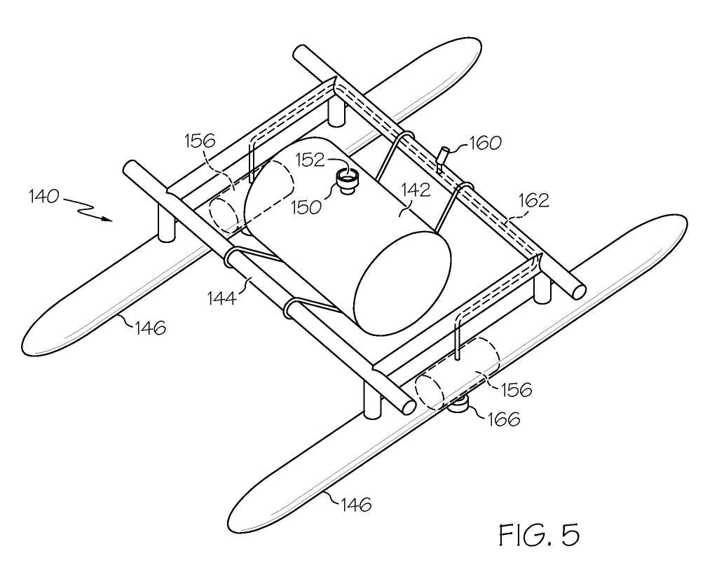

FIG. 5 show another embodiment of a collection system 140 according to an example form of the invention. A barrel or other container 142 is supported from a frame 144 carried on pontoon floats 146. The barrel 142 comprises a lower opening (unshown) for oil collection, and an upper opening 150 having a valve 152 for controlling flow through the upper opening. The pontoons comprise one or more ballast portions 156 for raising and lowering the level of the system relative to the water surface. A compressed air fitting 160 receives compressed air from a service vessel or other external source, and communicates the air via a hose, tubing or other conduit 162 to the ballast portions 156. Alternatively, an onboard pump or compressor is provided to supply compressed air, and/or to pump water out of the ballast portions. One or more ballast valves 166 allow selective control of water flow into and out of the ballast portions 156. Selective operation of the ballast portions 156 allows the system to be submerged to initially fill the container 142 with water, and raised to position the lower opening of the container into fluid communication with the layer of oil to be collected. In an example mode of operation, the upper exit valve 152 of the container 142 is opened, and the ballast sections 156 are allowed to take in water by opening the ballast valves 166, causing the system to submerge and fill the barrel 142 with water. The exit valve 152 is then closed, air is pumped into the ballast sections 156 to replace the ballast water, increasing the buoyancy and raising the system. Buoyancy is controlled to maintain the lower opening of the container 142 at a level in contact with the oil layer, causing lower density oil to replace higher density water within the container 142. The oil filled container 142 can then be collected and replaced, or oil can be collected from the container and the collection process repeated.

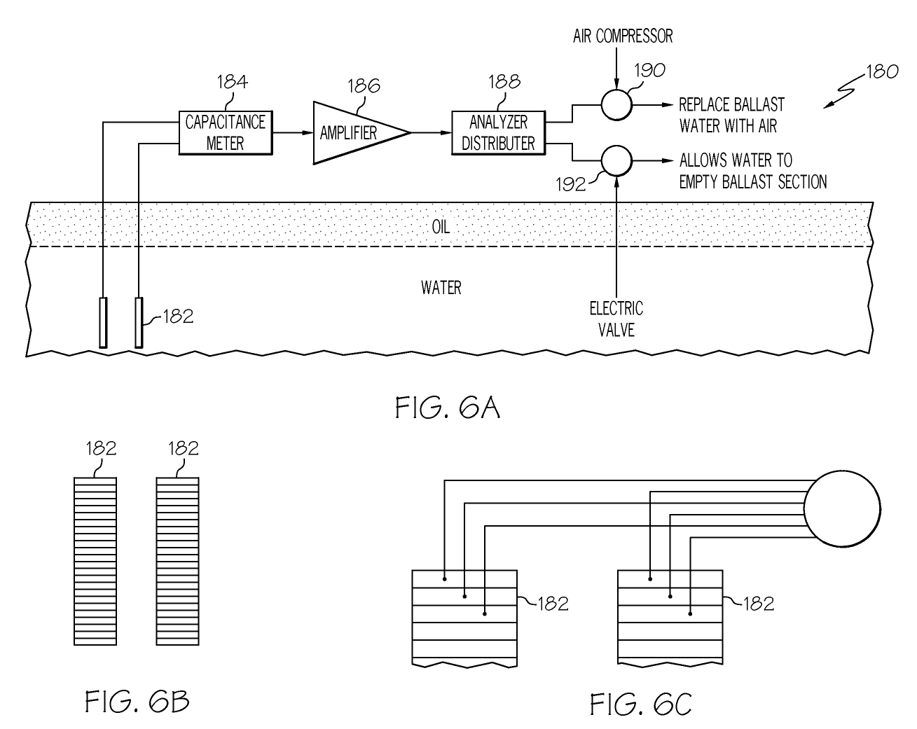

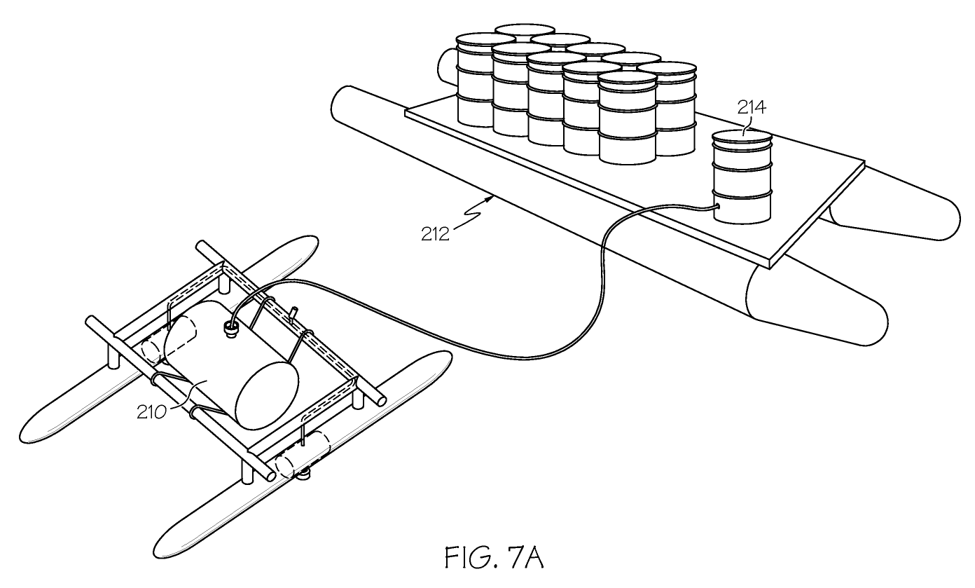

As shown in FIGS. 6A, 6B and 6C, a leveling sensor system 180 can be provided to maintain the position of the oil collection opening of the collection container at the optimal level within the layer of oil to be collected. The leveling sensor 180 serves to optimize the position of the collecting vessel mouth on the air/oil interface. If the oil layer is thick, the pontoon buoyancy is decreased to lower the system and move the vessel mouth deeper into the oil layer. If the oil layer is thin, the pontoon buoyancy is increased to raise the system, keeping the vessel mouth in the oil. In an example form shown in FIG. 6A, the leveling system preferably comprises a measuring sensor 182 (for example, a specially constructed capacitor), a signal (capacitance) meter 184, an amplifier 186, an analyzer/distributer 188, an air compressor 190 for delivering air to the pontoons, and an electric valve 192 for allowing exchange of air and water to/from the buoyancy sections of the pontoons. When the capacitor sensor 182 is submerged into a body of water covered with oil, the space between the sensor probes or plates fills with water (in the lower part of the sensor), oil (in the middle part of the sensor), and air (the top part of the sensor). Because for a water dielectric constant at 20° C., ε=80 (for oil ε is around 4, and for air ε is around 1) dielectric constant at least 20 times larger than water constant, and 80 time larger than air constant, the thickness of oil layer can be measured as a function of the capacitance measured by the sensor. The signal from the capacitance meter 184 coupled to the sensor 182 is amplified by the amplifier 186, goes to the amplifier/distributer 188, which sends a command to the compressor 190 (or a compressed air tank) or electric ballast valve 192. By replacing ballast water with air, or allowing water to enter the ballast compartment, the pontoon and collective chamber mouth are adjusted to the optimal level. In order to obtain information on the depth of the sensor immersion and thickness of individual layers (air, oil and water) the sensor plate is constructed of isolated conductive strips that are individually connected to the meter through a multiplexer, as shown in FIGS. 6B and 6C. The system provides the capacitance profile along the sensor plate length, which in turn gives the information on the position of the sensor relative to the air/oil interface and the oil layer thickness. For sea (ocean) water the capacitance sensor can be replaced by the electrical conductivity meter (salty water conductance is much higher than oil and air conductance). There are alternative sensors that can be used for the measurement of the oil/water profile.

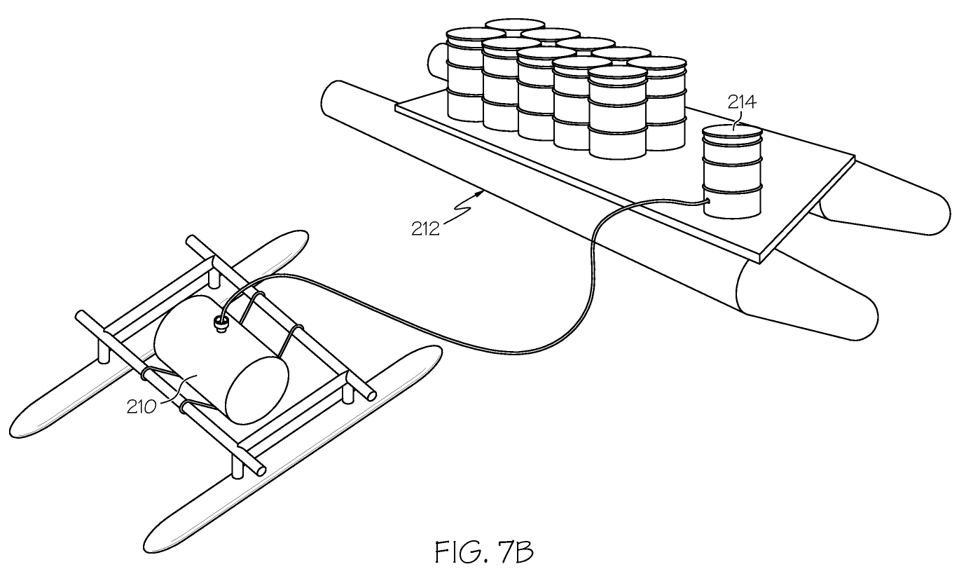

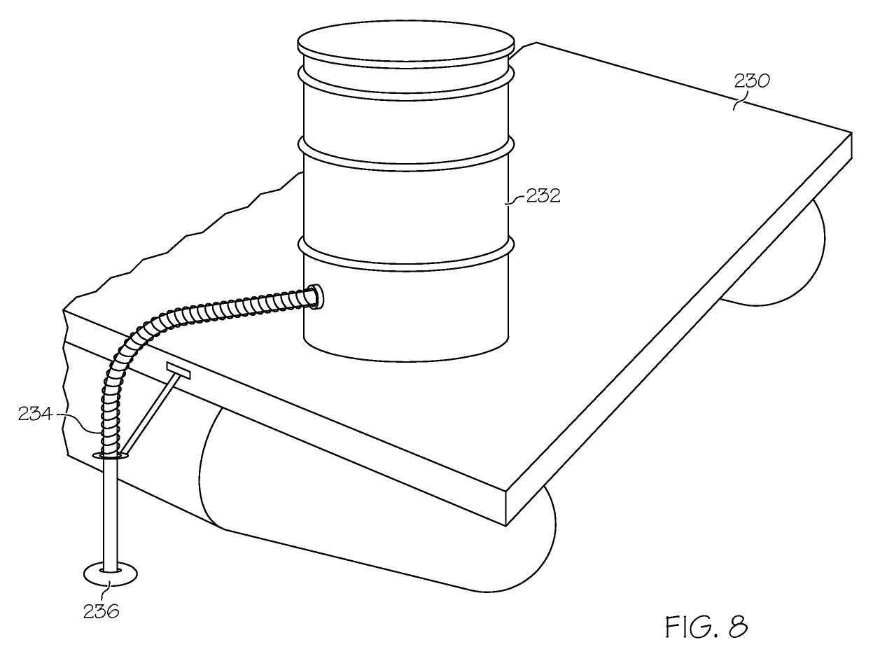

FIGS. 7A and 7B show systems and methods of transferring collected oil from the primary collection container 210 of a collection system to a service vessel or other secondary collection/transport system 212. One or more closed secondary containment structures 214 are provided in or on the secondary collection/transport system 212, and are initially charged with water (saltwater or freshwater) or other higher density material. When the primary collection container 210 has been filled with collected oil or other lower density material, one or more valves are opened to allow fluid flow through a conduit between an upper opening of the primary collection container and a lower opening of the secondary container 214. The elevation of the secondary container(s) 214 is maintained above that of the primary collection container 210, such that the oil from the primary container rises through the conduit to displace water in the secondary container, and the water from the secondary container flows down into the primary container in place of the oil. In this manner, oil is transferred from the primary container 210 and the primary container is refilled with water for further collection, without the need for pumping or mechanical transfer of containers.

FIG. 8 shows a collection system and method according to another example embodiment of the invention. In this embodiment, a boat, barge, platform, platoon, or other vessel 230 carries one or more collection containers 232, such as a barrel. A flexible collection hose 234 is connected at a first end to a valved opening at a lower portion of the barrel 232, and to a collection head 236 at a second end. The collection head is optionally donut-shaped or toroidal to maintain sealing contact against the water/oil surface it is applied to, around a central collection chamber. The barrel 232, hose 234 and collection head 236 are connected to allow fluid communication therebetween and sealed in an airtight manner. The barrel 232 is carried on the service vessel 230 at an elevation above the oil/water surface, is filled with water, and the hose is attached to the barrel exit port with the valve closed. When the valve is opened, the hose fills with water, makes a water contact with an outside head hose level, and the oil collection begins, with oil moving upward into the collection barrel 232 displacing water, which discharges down the hose 234 and out through the collection head 234. After the barrel is full, the valve is closed, and the hose may be connected to another barrel and the collection process repeated. The barrel may be used in vertical or horizontal positions, or alternatively a spherical or otherwise configured collection vessel may be utilized. In one embodiment the collecting vessel can be made from rubber-like material and be inflatable for better storage, economy, and convenience. Example vessels include flat for storage and stand by for transportation to the deployment point, and be ready for use within seconds.

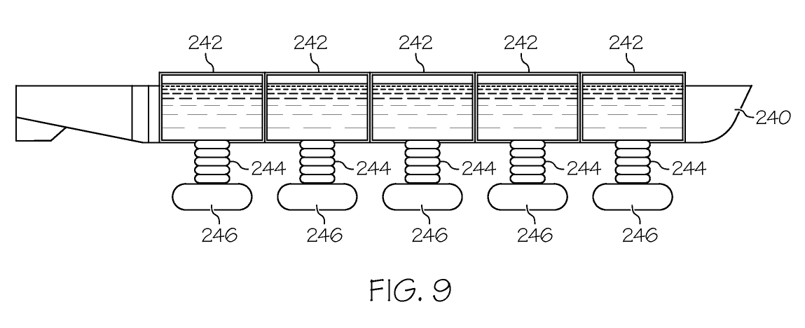

As shown in FIG. 9, the service vessel may use multiple hoses to collect many barrels or other containers at once. Using this concept a large tanker filled with sea water can collect oil by replacing the water with oil. The system can be scaled up and down depending on the intended application. The hose diameter is preferably about 20-30% of the barrel's or other container's height, and the distance between the barrel's or other container's top and the water level is preferably less than 10 meters.

While described herein primarily with application to maritime oil spills, it will be understood that the system and method of the present invention may be adapted for use in connection with collection of oil in saltwater or fresh water environments, in and around marinas, fueling areas, oil rigs, harbors and processing plants, and for coastal environmental defense against naturally occurring and/or manmade releases of oil and other petrochemicals. Additionally, while described primarily with regard to collection of oil from water, it will be understood that the system and method of the present invention may be adapted to separation of any lower density material from a higher density material, for example in specialty chemical processing, rendering of fats in meat processing plants, essential oil collection from plants, ore particle separation in mining, and various other applications and industrial processes where a density differential is present between a first material and a second material.

While the invention has been described with reference to preferred and example embodiments, it will be understood by those skilled in the art that a variety of modifications, additions and deletions are within the scope of the invention, as defined by the following claims.

What is claimed is:

1. A system for collecting a lower density material from a higher density material, said system comprising:
a container having a closed upper portion and a lower portion having an opening formed therein; and
a support structure for supporting the container with its upper portion elevated above a surface comprising the lower density material and maintaining the opening in the lower portion of the container in fluid communication with the lower density material.

2. The system of claim 1, wherein the container is initially charged with a quantity of the higher density material held in a column elevated above the surface.

3. The system of claim 1, wherein the support structure comprises a pontoon float.

4. The system of claim 1, wherein the support structure comprises a boat.

5. The system of claim 1, wherein the container is supported between a pair of floats.

6. The system of claim 1, wherein the support structure comprises a ballast portion for controlling the elevation of the support structure relative to the surface.

7. The system of claim 1, further comprising means for raising and lowering the container relative to the support structure.

8. The system of claim 1, further comprising a leveling system for maintaining the opening in the lower portion of the container in fluid communication with the lower density material, wherein the leveling system comprises a sensor.

9. The system of claim 1, wherein the container comprises a cylindrical barrel.

10. The system of claim 1, wherein the container is spherical.

11. The system of claim 1, wherein the container defines an internal contained volume having a height of less than about 10 meters.

12. The system of claim 1, wherein the container has a height and the opening in the lower portion of the container has a maximum dimension of no more than about 20% the height of the container.

13. The system of claim 12, wherein the opening in the lower portion of the container has a maximum dimension of about 15-20% the height of the container.

14. The system of claim 1, wherein the lower density material is oil.

15. The system of claim 1, wherein the higher density material is water.

16. The system of claim 1, further comprising a secondary containment structure for receiving a quantity of the lower density material from the container.

17. The system of claim 1, wherein the container contains a volume of air for generating buoyancy.

18. A system for collection of oil from an oil layer dispersed on a surface of a body of water, the system comprising:
a container having a lower opening and an internal contained volume;
at least one floatation device for floatation on the body of water; and
means for carrying the container on the at least one floatation device with the lower opening in communication with the oil layer, and with the internal contained volume elevated above the lower opening.

19. The system of claim 18, wherein the container is initially charged with a quantity of a higher density material held in a column elevated above the surface.

20. The system of claim 18, wherein the at least one flotation device comprises a pontoon float.

21. The system of claim 18, wherein the at least one flotation device comprises a boat.

22. The system of claim 18, wherein the container is supported between a pair of the floatation devices.

23. The system of claim 18, wherein the means for carrying the container comprises a ballast portion for controlling the elevation of the means for carrying the container relative to the surface.

24. The system of claim 18, further comprising means for raising and lowering the container relative to the means for carrying the container.

25. The system of claim 18, further comprising a leveling system for maintaining the opening in the lower portion of the container in fluid communication with the oil, wherein the leveling system comprises a sensor.

26. The system of claim 18, wherein the container comprises a cylindrical barrel.

27. The system of claim 18, wherein the container is spherical.

28. The system of claim 18, wherein the container defines an internal contained volume having a height of less than about 10 meters.

29. The system of claim 18, wherein the opening in the lower portion of the container has a maximum dimension of no more than about 20% the height of the container.

30. The system of claim 29, wherein the opening in the lower portion of the container has a maximum dimension of about 15-20% the height of the container.

31. The system of claim 18, further comprising a secondary containment structure for receiving a quantity of the oil from the container.

32. The system of claim 18, wherein the container contains a volume of air for generating buoyancy.

33. A method for collection of a lower density material from a higher density material, the method comprising:
placement of a container with a transfer opening in fluid communication with the lower density material;
charging a contained volume of the container with a quantity of the higher density material;
positioning the container with its contained volume elevated above the transfer opening;
maintaining an airtight seal around the contained volume to retain an elevated column of fluid; and
allowing transfer of the lower density material through the transfer opening into the contained volume to displace the higher density material therefrom.

34. The method of claim 33, further comprising supporting the container with a support structure.

35. The method of claim 34, wherein the support structure comprises a pontoon float.

36. The method of claim 34, wherein the support structure comprises a boat.

37. The method of claim 34, wherein the support structure comprises a pair of floats.

38. The method of claim 34, wherein the support structure comprises a ballast portion for controlling the elevation of the support structure relative to the lower density material.

39. The method of claim 33, further comprising raising and lowering the container relative to the lower density material.

40. The method of claim 33, further comprising maintaining the transfer opening of the container in fluid communication with the lower density material through use of a sensor.

41. The method of claim 33, wherein the container comprises a cylindrical barrel.

42. The method of claim 33, wherein the container is spherical.

43. The method of claim 33, wherein the container defines an internal contained volume having a height of less than about 10 meters.

44. The method of claim 33, wherein the transfer opening of the container has a maximum dimension of no more than about 20% the height of the container.

45. The method of claim 33, wherein the transfer opening of the container has a maximum dimension of about 15-20% the height of the container.

46. The method of claim 333, wherein the lower density material is oil.

47. The method of claim 33, wherein the higher density material is water.

48. The method of claim 33, further comprising transferring a quantity of the lower density material from the container to a secondary containment structure.

49. The method of claim 33, wherein the container contains a volume of air for generating buoyancy.
